(19) United States
(12) Patent Application Publication
(10) Pub. No.: US 2020/0341700 A1
(43) Pub. Date: Oct. 29, 2020

(54) IMAGE FORMING APPARATUS, IMAGE FORMING SYSTEM, MANAGEMENT APPARATUS, AND PROGRAM

(71) Applicant: KONICA MINOLTA, INC., Tokyo (JP)

(72) Inventor: Masayuki YASUKAGA, Tokyo (JP)

(73) Assignee: KONICA MINOLTA, INC., Tokyo (JP)

(21) Appl. No.: 16/840,622

(22) Filed: Apr. 6, 2020

(30) Foreign Application Priority Data
Apr. 25, 2019 (JP) 2019-083971

(51) Int. Cl. G06F 3/12; H04N 1/00

(52) U.S. Cl. CPC G06F 3/1208; H04N 1/00639; G06F 3/1256

(57) ABSTRACT

An image forming apparatus includes: an image former that forms an image on a basis of a print job; and a hardware processor that controls the image former and can perform a proof printing function, wherein the hardware processor performs, for a print job including post-processing process setting, control for performing another post-processing process different from a post-processing process set in a print job when a proof printing function is performed.

The entire disclosure of Japanese patent Application No. 2019-083971, filed on Apr. 25, 2019, is incorporated herein by reference in its entirety.

### BACKGROUND

### Technological Field

The present invention relates to an image forming apparatus, an image forming system, a management apparatus, and a program, capable of setting a post-processing process and performing control for performing a proof printing function.

### Description of the Related Art

In an image forming apparatus that performs printing on the basis of a print job, various post-processing processes such as stapling, punching, and cutting can be performed by connecting a finisher option to a printed sheet. In general, the contents of a post-processing process are set for a print job.

Some image forming apparatuses have a proof printing function of performing trial printing in order to determine whether images of printed matters printed by the image forming apparatuses are normal.

In the above apparatuses, when a proof printing function is used for a print job for which post-processing is set, the set post-processing is performed on an output product.

Furthermore, a conventional image forming apparatus has been proposed in which a plurality of trial post-processing settings can be performed in one print setting. When proof printing is performed, it is easy to try various post-processing settings for a print job (see JP 2008-152472 A).

Specifically, by disposing a print setting screen display means for displaying a print setting screen; a trial post-processing setting UI display means for, when a trial post-processing mode is designated on a print setting screen displayed by the print setting screen display means, displaying the trial post-processing setting UI; and a collective designation means for collectively designating a plurality of post-processing methods on the trial post-processing setting UI screen displayed by the trial post-processing setting UI display means, it is possible to execute a plurality of types of trial printing and trial post-processing without repeating processing of “setting→printing→post-processing”.

However, in the conventional image forming apparatus, in the post-processing setting, for example, when cutting setting is performed, cutting is performed even when a user wants to confirm a balance between an image position and a cutting position in proof printing. Therefore, a sheet breaks apart, and it is not clear where a cut piece was originally located (whether a cut piece was at the top right or the bottom left of the sheet before cutting). For this reason, even if a problem is found in a balance between an image position and a cutting position in the output product, it is difficult to find whether the image position is bad or setting of the cutting position is bad, or which of the plurality of cutting position settings is bad, disadvantageously.

In addition, when stapling or punching is performed during proof printing, post-processing process parts and members (staples and the like) are consumed disadvantageously.

### SUMMARY

The present invention has been achieved in view of the above circumstances. An object of the present invention is to provide an image forming apparatus, an image forming system, a management apparatus, and a program, capable of obtaining an output product in which consumption or the like of members is suppressed or an output product in which a user easily confirms a post-processing position for a print job for which post-processing is set during output by a proof printing function.

To achieve the abovementioned object, according to an aspect of the present invention, an image forming apparatus reflecting one aspect of the present invention comprises: an image former that forms an image on a basis of a print job; and a hardware processor that controls the image former and can perform a proof printing function, wherein the hardware processor performs, for a print job including post-processing process setting, control for performing another post-processing process different from a post-processing process set in a print job when a proof printing function is performed.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a schematic configuration of an image forming system according to an embodiment of the present invention;

FIG. 2 is a diagram illustrating a control block of an image forming apparatus according to an embodiment of the present invention;

FIG. 3 is a diagram for explaining an example of cutting setting;

FIG. 4 is a diagram illustrating a sheet after cutting;

FIG. 5 is a diagram for explaining an example in which a post-processing process of cutting setting is performed with different contents in proof printing of job printing;

FIG. 6 is a diagram for explaining an example in which a post-processing process of stapling setting is performed with different contents in proof printing of job printing;

FIG. 7 is a flowchart illustrating a procedure for performing a post-processing process by another post-processing process in proof printing; and

FIG. 8 is a diagram illustrating a setting screen when a post-processing process is changed to another post-processing process (alternative processing) during proof printing.

### DETAILED DESCRIPTION OF EMBODIMENTS

Hereinafter, an image forming apparatus and an image forming system according to one or more embodiments of the present invention will be described with reference to the drawings. However, the scope of the invention is not limited to the disclosed embodiments.

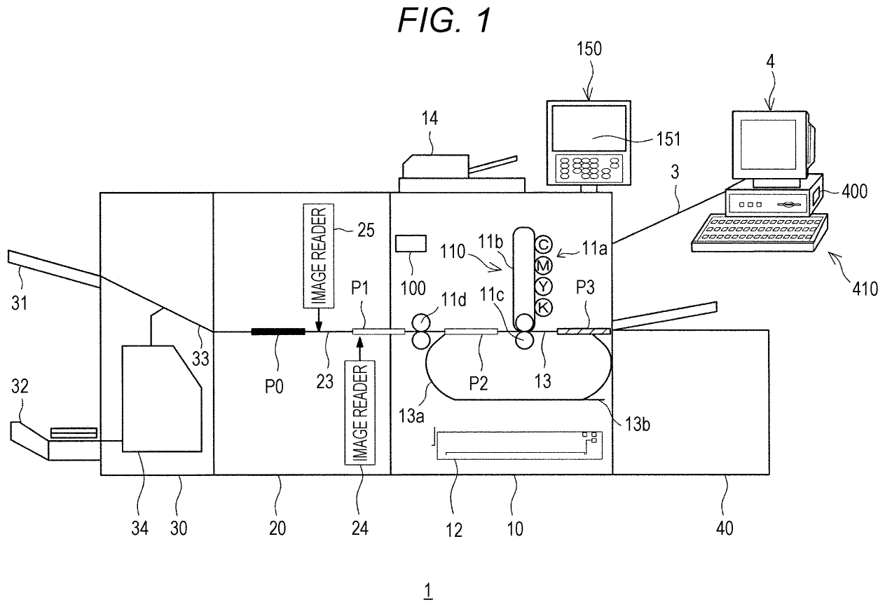

FIG. 1 is a central cross-sectional view of an image forming system including an image forming apparatus, and illustrates a mechanical configuration thereof. The configuration will be described below.

An image forming system 1 includes an apparatus main body 10, an image inspection unit 20 located on a downstream side thereof, a post-processing apparatus 30 located on a further downstream side thereof, and a sheet feeder 40 located on an upstream side of the apparatus main body 10. The apparatuses are mechanically and electrically connected to each other. A sheet can be conveyed between the apparatuses, and information can be transmitted and received between the apparatuses. In the present embodiment, these apparatuses constitute the image forming system 1, and the apparatus main body 10 and the sheet feeder 40 constitute the image forming apparatus.

Note that as the present invention, the configurations of the image forming system and the image forming apparatus are not limited to the above, and the image forming apparatus may be constituted by adding the post-processing apparatus 30 to the apparatus main body 10. Hereinafter, a configuration of each of the apparatuses will be specifically described.

In the apparatus main body 10, an operation unit 150 is disposed on an upper side of a housing. The operation unit 150 includes a touch panel type LCD 151. An operator can operate the LCD 151 and can display information on the LCD 151. The LCD 151 serves as both an operation unit and a display unit, and functions as an operation display unit according to an embodiment of the present invention. Note that the operation unit can be constituted by a mouse, a tablet, or the like, and can be constituted separately from the display unit. These components constitute the operation display unit. The LCD 151 may be movable. The operation unit 150 functions as a user interface.

On a lower side of the apparatus main body 10, a main body sheet feeder 12 having a plurality of main body trays that stores and feeds a sheet is disposed. On an upstream side of the apparatus main body 10, the sheet feeder 40 having a plurality of large-capacity sheet feeding trays is disposed. The sheet feeder 40 stores a sheet and feeds the sheet to the apparatus main body 10. Note that in this embodiment, a sheet corresponds to a recording medium according to an embodiment of the present invention. Note that the recording medium is not limited to a sheet, but may be cloth, plastic, or the like.

A conveyance path 13 that conveys a sheet fed from the main body sheet feeder 12 or the sheet feeder 40 is disposed in the apparatus main body 10, and an image former 110 is disposed in the middle of the conveyance path in the apparatus main body 10. The image former 110 includes photoconductors 11a for respective colors (cyan (C), magenta (M), yellow (Y), and black (K)). A charger, an LD, and a developer (not illustrated) are disposed around each of the photoreceptors 11a. Furthermore, the image former 110 includes an intermediate transfer belt 11b that transfers an image on the photoreceptor 11a and a secondary transfer unit 11c that transfers an image on the intermediate transfer belt 11b onto a sheet.

On the conveyance path 13 on a downstream side of the secondary transfer unit 11c, a fixing device 11d is disposed.

The photoreceptor 11a, the charger (not illustrated), the LD (not illustrated), the developer (not illustrated), the intermediate transfer belt 11b, the secondary transfer unit 11c, the fixing device 11d, and the like constitute the image former 110. Note that the image former may form an image in a single color, or may be able to print only a single color.

The conveyance path 13 has a reverse conveyance path 13a branched from a straight side on a downstream side of the fixing device 11d. The reverse conveyance path 13a joins the conveyance path 13 on an upstream side of the image former 110 on a downstream side after a retreat conveyance path 13b branches off.

When a sheet is reversed and recirculated to the image former 110, the sheet is once sent from the reverse conveyance path 13a to the retreat conveyance path 13b, then is sent back to the reverse conveyance path 13a on a downstream side, and is joined to the conveyance path 13 on an upstream side of the image former 110 to form an image on the back side of the sheet.

The image former 110, the main body sheet feeder 12, the sheet feeder 40, the conveyance path 13, the reverse conveyance path 13a, and the like constitute a printer unit.

The apparatus main body 10 includes a controller 100. The controller 100 controls the entire image forming system 1, and is constituted by a CPU, a program executed by the CPU, a parameter, a storage unit serving as a work area, and the like. For a print job including post-processing process setting performed by the image forming apparatus, the controller 100 can perform control for performing another post-processing process different from a post-processing process set in the print job when a proof printing function is performed. That is, in this case, the controller 100 corresponds to a computer according to an embodiment of the present invention, and a program executed by the controller 100 includes a program according to an embodiment of the present invention.

The image inspection unit 20 includes a conveyance path 23 whose upstream side is connected to the conveyance path 13 of the apparatus main body 10 and whose downstream side is connected to a conveyance path 33 of the post-processing apparatus 30.

An image reader 24 that reads an image on a lower surface of a sheet is disposed on an upstream side in the middle of the conveyance path 23, and transmits a reading result to the controller 100. The image reader 24 may be a line sensor or a colorimeter or the like that reads an image at a point. The drawing illustrates a state where the sheets P0 and P1 are sequentially conveyed.

An image reader 25 that reads an image on an upper surface of a sheet is disposed on the conveyance path 23 on a downstream side of the image reader 24, and transmits a reading result to the controller 100. The image reader 25 may be a line sensor or a colorimeter or the like that reads an image at a point.

The controller 100 can determine whether or not an image is correct by comparing a read image with a correct image. The image inspection unit 20 may include an image comparison unit, and the image comparison unit may determine whether or not an image is correct. The image comparison unit can be constituted by a CPU, a storage unit, a program, and the like.

The post-processing apparatus 30 includes the conveyance path 33 connected to the conveyance path 23. The conveyance path 33 is connected to a first sheet discharging unit 31 on a straight side, and connected to a second sheet discharging unit 32 via a post-processor 34 on a branch side.

After image inspection is performed as desired, a sheet conveyed on the conveyance path 23 is sent to the conveyance path 33 of the post-processing apparatus 30 and is discharged to the first sheet discharging unit 31 without being subjected to post-processing. Alternatively, the sheet is subjected to predetermined post-processing in the post-processor 34 and is discharged to the second sheet discharging unit 32. The post-processor 34 may perform a plurality of types of post-processing.

The post-processor 34 executes predetermined post-processing. Examples of the post-processing include appropriate processing such as stapling, punching, booklet-making, saddle stitching, and cutting. The post-processor that performs cutting corresponds to a cutting apparatus according to an embodiment of the present invention. A sheet not subjected to post-processing is discharged to the first sheet discharging unit 31. A sheet that has passed through the post-processor 34 is discharged to the second sheet discharging unit 32 as a bundle.

A cutting apparatus may be disposed off-line outside the image forming apparatus.

An external device 4 is connected to the image forming apparatus via a network.

The external device 4 includes an external device controller 400 that controls the external device 4, and includes an external device operation unit 410 that can perform operation and display. The external device 4 can generate a print job and send the print job to the image forming apparatus via a network 3.

The external device 4 may have a function as a management apparatus that controls the image forming apparatus. In this case, the external device controller 400 can function as a management controller. For a print job including post-processing process setting performed by the image forming apparatus, the management controller can perform, as one of controls, control for performing another post-processing process different from a post-processing process set in the print job when a proof printing function is performed. In this case, the management controller functions as a computer according to an embodiment of the present invention, and a program executed by the computer includes a program according to an embodiment of the present invention.

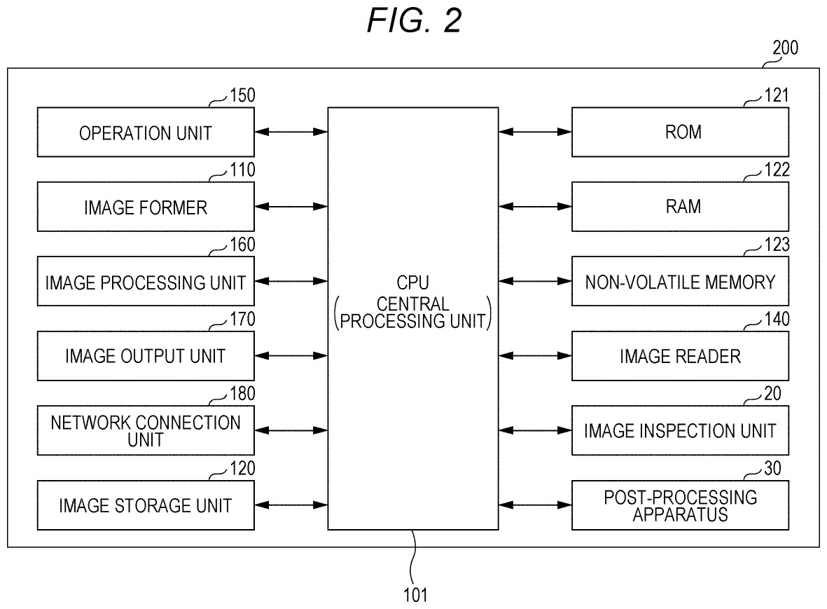

FIG. 2 is a diagram illustrating a control block of the image forming system of FIG. 1.

A control block 200 includes an operation unit 150 that can be operated and can display information, an image reader 140 that reads a document, an image processing unit 160 that performs processing on image data, an image former 110 that forms an image on a sheet or the like on the basis of image data processed by the image processing unit 160, an image storage unit 120 that stores data, an image output unit 170 that controls a print process of image data, a network connection unit 180 that controls connection of the image forming apparatus with a communication line and another device, a central processing unit (CPU) 101 that controls the entire system, a ROM 121 that stores non-rewritable read-only data, a RAM 122 that temporarily stores data, a non-volatile memory 123 that can rewrite data and includes a hard disk drive (HDD) or the like, and the post-processor 34 that performs post-processing on a read document and/or an image-formed sheet. The CPU 101, the ROM 121, the RAM 122, the non-volatile memory 123, and a program constitute the controller 100 according to an embodiment of the present invention

Each module is controlled on the basis of communication and a control signal with the CPU 101 at the center. Image data read by the image reader 140 is temporarily stored in a file memory area secured on the RAM 121. Then, a file of the image read by the image processing unit 160 is generated, and the generated file is stored in the image storage unit 120.

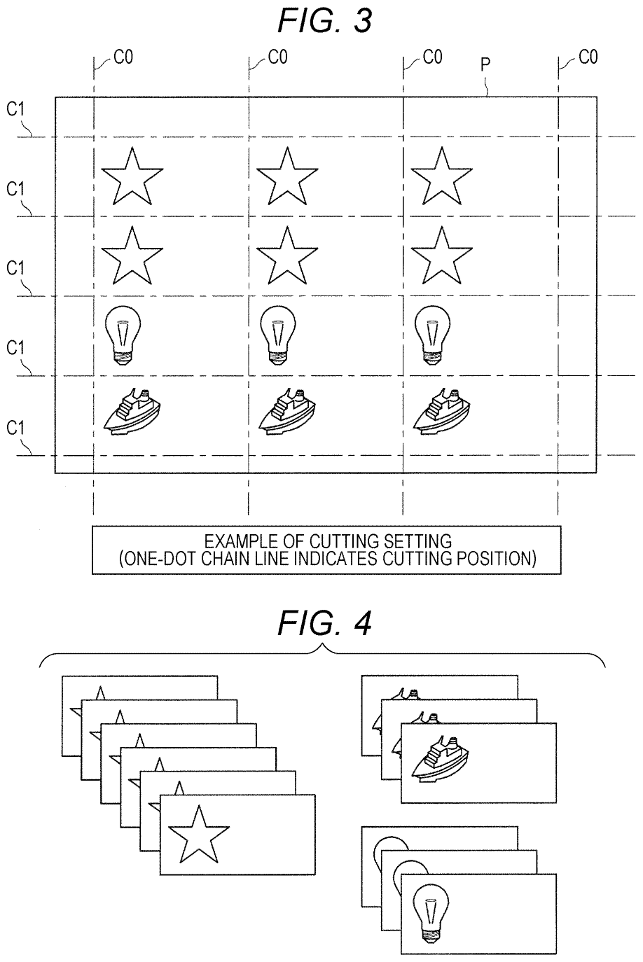

Next, an example in which cutting is performed as post-processing will be described with reference to FIGS. 3 and 4.

As illustrated in FIG. 3, it is assumed that there is a print job in which cutting is set so as to perform cutting along one-dot chain lines C0 and C1 (hereinafter, referred to as “print job A”).

When a proof printing function is performed on the print job A, as illustrated in FIG. 4, a sheet P is cut along the one-dot chain lines C0 and C1. For this reason, even if a problem is found in a balance between an image position and a cutting position in the output product, it is difficult to find whether the image position is bad or setting of the cutting position is bad, or which of the plurality of cutting position settings is bad, disadvantageously.

Therefore, only during proof printing, the post-processing process is replaced with another post-processing process.

A post-processing setting to be replaced and a post-processing setting to be performed instead may be selected by a user.

For example, a post-processing process may be performed only in the horizontal direction or the vertical direction with respect to a sheet passing direction. The post-processing setting to be performed instead may be selected/determined from post-processing settings in the same direction as the post-processing setting of the replacement source. For example, some image forming apparatuses include a horizontal perforation module, a vertical perforation module, and a crease module (only in the horizontal direction).

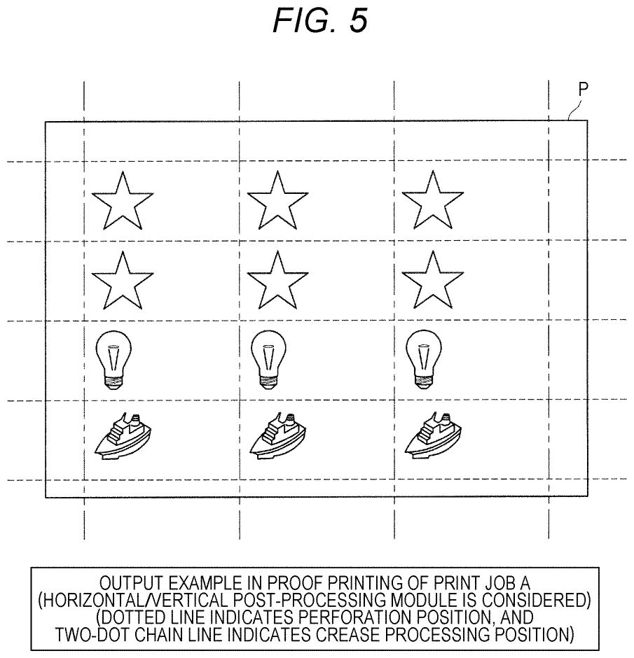

In FIG. 5, a cutting line is indicated by a perforation processing position in the horizontal direction, and is indicated by a crease processing position in the vertical direction. With a proof printing function, a cutting position can be confirmed without cutting.

A plurality of post-processing options may be connected to the image forming apparatus. Since there is a case where a post-processing position fine adjustment value is different for each post-processing option, the post-processing setting to be performed instead may be selected/determined from post-processing settings that can be performed with the same post-processing option as the post-processing setting of the replacement source. * A situation is assumed in which a plurality of post-processing options that can perform cutting, perforation processing, stapling, and punching can be connected.

An example of cutting has been described above. However, a case where replacement with another post-processing process is performed in order to suppress consumption of members such as staples can be similarly considered.

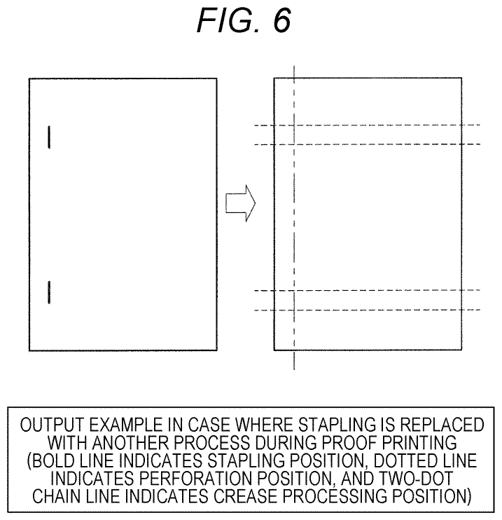

FIG. 6 is an output example in a case where stapling as a post-processing process is replaced with another process during proof printing. The bold line in the left drawing indicates a stapling position, the dotted line indicates a perforation processing position, and the two-dot chain line indicates a crease processing position. The stapling position can be indicated by the perforation processing position and the crease processing position. This eliminates unnecessary use of staples for stapling during proof printing.

The processing position can be indicated by the proof printing function as described above.

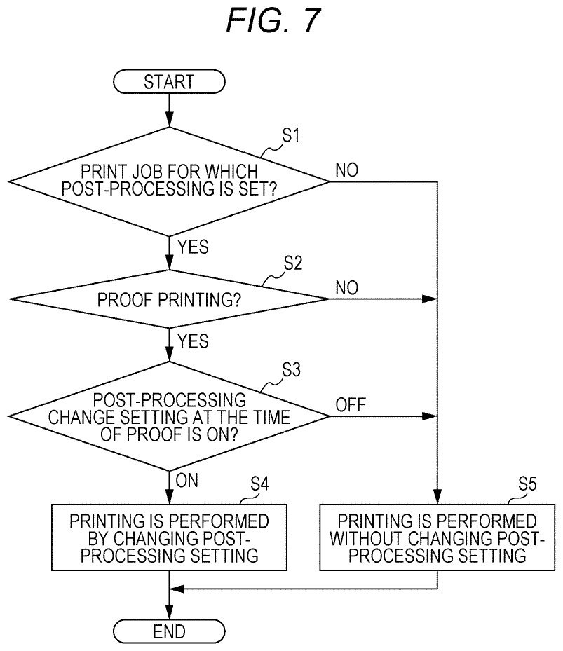

Next, when a job is printed, a procedure of confirming whether the job is proof printing and performing control will be described with reference to the flowchart of FIG. 7. The following procedure is controlled by a computer according to an embodiment of the present invention.

First, it is determined whether the job is a print job for which post-processing is set (step s1). If the job is not a print job for which post-processing is set (step s1, NO), printing is performed without changing post-processing setting (step s5), and then the process ends.

If the job is a print job for which post-processing is set (step s1, YES), it is determined whether the job is proof printing (step s2). If the job is not proof printing (steps s2, NO), the process proceeds to step s5 to perform printing without changing post-processing setting.

If the job is proof printing in step s2 (step s2, YES), it is determined whether post-processing change setting at the time of proof is ON. The post-processing change setting may be set in advance by machine setting or the like, or may be set such that a user can set ON and OFF via the operation unit. ON and OFF may be set according to the contents of setting of a post-processing process. For example, the post-processing change setting is set to ON in cutting, stapling, punching, and the like, and is set to OFF in the other post-processing processes.

If the post-processing change setting is OFF (steps s3, OFF), the process proceeds to step s5, and printing is performed without changing the post-processing setting.

If the post-processing change setting is ON (step s3, ON), printing is performed by changing post-processing setting (step s4). The contents of the post-processing setting to be changed may be set in advance by machine setting or the like, or may be set in advance by user setting. The contents of the post-processing setting to be changed may be inquired of a user, and the user may select the contents arbitrarily or from a plurality of predetermined change contents.

After printing, the process ends.

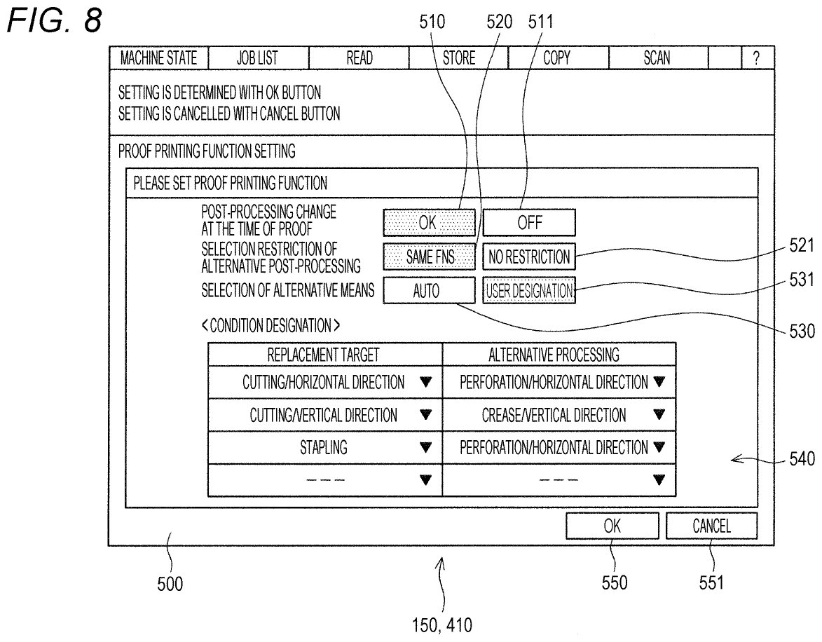

A setting screen when post-processing setting is changed in proof printing will be described with reference to FIG. 8.

A setting screen 500 can be operably displayed on the operation unit 150, the external device operation unit 410, or the like.

The setting screen 500 can be a screen that has transitioned from a proof printing function setting screen.

On the setting screen 500, an ON button 510 and an OFF button 511 for setting ON/OFF of post-processing change at the time of proof are displayed so as to be able to be pressed, and either one can be selected and pressed. On the screen illustrated in the drawing, ON is set.

Furthermore, on the setting screen 500, below the ON button 510 and the OFF button 511, as buttons for selecting selection restriction of alternative post-processing, a “same FNS” button 520 and a “no restriction” button 520 are displayed so as to be able to be pressed. When the “same FNS” button 520 is pressed, initial post-processing is executed by the same post-processor after the post-processing contents are changed. When the “no restriction” button 520 is pressed, selection of the post-processor is not restricted. In the drawing, the “same FNS” button has been selected. These buttons may be able to be pressed only when the post-processing change at the time of proof is ON.

Furthermore, buttons for selecting alternative means are displayed below the “same FNS” button 520 and the “no restriction” button 520. That is, an “auto” button 530 and a “user designation” button 531 are displayed so as to be able to be pressed.

When the “auto” button 530 is pressed, a preset alternative means is selected. When the “user designation” button 531 is pressed, an alternative means designated by a user is selected. In the drawing, user designation has been selected.

A list 540 of alternative means is displayed below the buttons, and each item can be selected.

In the list 540, post-processing setting of a replacement target is displayed on the left, and post-processing setting of alternative processing is displayed on the right. The contents of alternative processing for a list item of a replacement target on the left can be selected from among the list items on the right. In the list items, a selectable replacement target or contents of alternative processing are displayed in a list, and alternative processing of a function can be selected.

In the drawing, perforation/horizontal direction is selected for a replacement target of cutting/horizontal direction, and crease/vertical direction is selected for a replacement target of cutting/vertical direction.

Alternative processing of perforation/horizontal direction is selected for a replacement target of stapling. For a list item of a replacement target on the left, only a process that can be replaced may be displayed and selected from among the list items on the right.

On the setting screen 500, at the bottom, an OK button 550 and a cancel button 551 are displayed so as to be able to be pressed. When the OK button 550 is pressed, the set items and the initial setting items are determined. When the cancel button 551 is pressed, a set item is cancelled.

According to an embodiment of the present invention, by performing, for a print job for which post-processing is set, post-processing different from post-processing set for a job during output by a proof printing function, it is possible to obtain an output product in which consumption or the like of members is suppressed or a user easily confirms a post-processing position. Note that, post-processing set in a print job can be performed during normal printing.

Although embodiments of the present invention have been described and illustrated in detail, the disclosed embodiments are made for purposes of illustration and example only and not limitation, and the present embodiment can be appropriately modified without departing from the scope of the present invention. The scope of the present invention should be interpreted by terms of the appended claims

What is claimed is:

1. An image forming apparatus comprising:
an image former that forms an image on a basis of a print job; and
a hardware processor that controls the image former and can perform a proof printing function, wherein
the hardware processor performs, for a print job including post-processing process setting, control for performing another post-processing process different from a post-processing process set in a print job when a proof printing function is performed.

2. The image forming apparatus according to claim 1, wherein the hardware processor performs another post-processing process on a part of the post-processing process setting when a proof printing function is performed.

3. The image forming apparatus according to claim 1, wherein the post-processing process setting for performing another post-processing process is at least one of cutting, stapling, and punching.

4. The image forming apparatus according to claim 1, wherein on a part or a whole of a print job including the post-processing process setting, the hardware processor can set whether to perform another post-processing process different from a post-processing process set in the print job when a proof printing function is performed.

5. The image forming apparatus according to claim 1, wherein on a part or a whole of a print job including the post-processing process setting, the hardware processor can set whether to use a post-processor different from a post-processor used in usual post-processing when another post-processing process different from a post-processing process set in the print job is performed when a proof printing function is performed.

6. The image forming apparatus according to claim 1, wherein the hardware processor performs control for performing another post-processing process designated by a user when a specific post-processing process designated by the user is set in a print job.

7. The image forming apparatus according to claim 1, wherein the other post-processing process is determined from a post-processing module for horizontal direction/vertical direction connected to a post-processing option.

8. The image forming apparatus according to claim 1, wherein the other post-processing process is selected from post-processing processes that can be performed with the same post-processing option.

9. An image forming system comprising: the image forming apparatus according to claim 1; and a post-processing apparatus that performs a post-processing process.

10. A management apparatus that manages an image forming apparatus including an image former that forms an image on a basis of a print job,
the management apparatus comprising a management controller that controls operation of the image forming apparatus, wherein
the management controller performs, on a print job including post-processing process setting performed by the image forming apparatus, control for performing another post-processing process different from a post-processing process set in the print job when a proof printing function is performed.

11. A non-transitory recording medium storing a computer readable program executed by a computer that controls an image forming apparatus including an image former that forms an image on a basis of a print job,
the program causing the computer to execute:
for a print job including post-processing process setting performed by the image forming apparatus, controlling for performing another post-processing process different from a post-processing process set in the print job when a proof printing function is performed.
